(19) United States
(12) Patent Application Publication
(10) Pub. No.: US 2024/0375094 A1
(43) Pub. Date: Nov. 14, 2024

(54) METHOD FOR IMPROVING THE COATING OF A HONEYCOMB BODY WITH A CATALYTICALLY ACTIVE COATING

(71) Applicant: Vitesco Technologies GmbH, Regensburg (DE)

(72) Inventors: Oswald HOLZ, Bergisch Gladbach (DE); David ODENTHAL, Bergisch Gladbach (DE)

(21) Appl. No.: 18/291,766

(22) PCT Filed: Jul. 15, 2021
(86) PCT No.: PCT/EP2022/069901

§ 371 Date: Jan. 24, 2024

(30) Foreign Application Priority Data
Jul. 28, 2021 (DE) 10 2021 208 131.2

(51) Int. Cl. B01J 37/02; B01D 53/94; B01J 35/57; B01J 37/08

(52) U.S. Cl. CPC B01J 37/0217; B01D 53/94; B01J 35/57; B01J 37/082; B01D 2258/01

(57) ABSTRACT

A method for producing a device for the aftertreatment of exhaust gases and for coating a honeycomb body, provided in the device, with a catalytically active surface coating. The honeycomb body is formed from a multiplicity of metallic, at least partially structured foils stacked one on another and wound so that the honeycomb body forms a multiplicity of flow channels through which fluid can flow along a main flow direction. The honeycomb body is received in an inner casing and is durably connected thereto. The inner casing is arranged in an outer casing serving as a housing and is durably connected thereto. Before the introduction of the catalytically active coating into the flow channels formed by the honeycomb body, an air gap or air gaps, which have been formed between the outer casing and the components arranged therein, are filled by a filler.

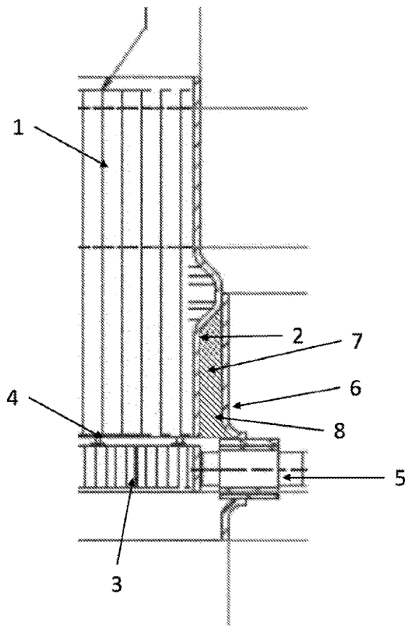

### CROSS REFERENCE TO RELATED APPLICATIONS

This is a U.S. national stage of Application No. PCT/EP2022/069901 filed Jul. 15, 2022. Priority is claimed on German Application No. DE 10 2021 208 131.2 filed Jul. 28, 2021, the content of which is incorporated herein by reference.

### BACKGROUND OF THE INVENTION

### 1. Field of the Invention

The disclosure relates to a method for producing a device for the aftertreatment of exhaust gases and for coating a honeycomb body, provided in the device, with a catalytically active surface coating, wherein the honeycomb body is formed from a multiplicity of metallic, at least partially structured foils stacked one on another and wound so that the honeycomb body forms a multiplicity of flow channels through which fluid can flow along a main flow direction, wherein the honeycomb body is received in an inner casing and is durably connected thereto, wherein the inner casing is arranged in an outer casing serving as a housing and is durably connected thereto.

### 2. Description of the Related Art

Honeycomb bodies for catalytic converters for the exhaust gas aftertreatment of internal combustion engines have a multiplicity of flow channels through which fluid can flow along a main flow direction. Honeycomb bodies, in particular honeycomb bodies made of metal, are formed by a plurality of smooth and/or at least partially structured metal foils stacked one on another and wound to form the final honeycomb body. For stabilization, and in order to protect against disruptive mechanical effects, the matrix formed from the metal foils is inserted in a housing and is durably connected thereto.

In the simplest case, the housing is formed by a tube, which is configured to receive the matrix in its interior. A further function of the housing is to ensure the flow through the honeycomb body, and in particular to prevent exhaust gas from flowing past the honeycomb body.

The matrix must on the one hand be durably fastened in the housing, and at the same time the housing should be as lightweight as possible and therefore constructed with thin walls. Some embodiments of catalytic converters have an inner casing which directly receives the matrix. The inner casing is then braced in relation to the housing or the outer casing by suitable supports.

A disadvantage of the devices in the prior art is that air gaps may arise between the individual elements of a catalytic converter, for example between the inner casing and the outer casing, and when the matrix is coated with a catalytically active material (the so-called washcoat) these air gaps can become clogged by this material. This material that has settled in the air gaps may become loosened by mechanical vibrations and thermal effects during operation, and this may cause damage and/or catalytic deactivation of downstream components for the exhaust gas aftertreatment.

Furthermore, it is disadvantageous that the washcoat introduced in a gap does not take part in the catalytic reaction on the honeycomb body, and it therefore fulfills no function. The amount of washcoat actually needed for coating the honeycomb body is therefore in fact less. The unnecessary additional consumption is a disadvantage in particular when the washcoat contains noble metals, which are expensive.

### SUMMARY OF THE INVENTION

An object of one aspect of the present invention is to provide a method that makes it possible to coat the honeycomb body in a housing as accurately as possible with the minimum amount of washcoat required, and to avoid introducing washcoat into regions that do not take part in the catalytic reaction.

One exemplary aspect of the invention relates to a method for producing a device for the aftertreatment of exhaust gases and for coating a honeycomb body, provided in the device, with a catalytically active surface coating, wherein the honeycomb body is formed from a multiplicity of metallic, at least partially structured foils stacked one on another and wound so that the honeycomb body forms a multiplicity of flow channels through which fluid can flow along a main flow direction, wherein the honeycomb body is received in an inner casing and is durably connected thereto, wherein the inner casing is arranged in an outer casing serving as a housing and is durably connected thereto, wherein, before the introduction of the catalytically active coating into the flow channels formed by the honeycomb body, an air gap or air gaps that have formed between the outer casing and the components arranged therein are filled by a filler.

A basic method for producing a device having a honeycomb body in an inner casing, which is durably received in an outer casing, is known from the prior art. The matrix is produced by stacking metal foils, which are at least partially structured, one on another and subsequently winding the layer stack produced in this way around a mandrel or a plurality of mandrels. The matrix of the honeycomb body is connected to the inner casing, for example by a soldering method, after the matrix has been inserted into the inner casing.

The inner casing is preferably made very thin and is essentially used to stabilize the matrix, so that the latter does not uncoil or spread out.

The honeycomb body is subsequently inserted into a housing that serves as closure from the surroundings, is formed by an outer casing, and is durably connected thereto, for example by soldering. The outer casing is substantially thicker than the inner casing and serves for guidance of the exhaust gas flow, mechanical support of the honeycomb body and attachment to further components for the exhaust gas aftertreatment.

Gaps may be formed, in particular between the inner casing and the outer casing, because of tolerances or simply because of the geometry of the individual constituent parts. A gap running fully around in the circumferential direction is in this case generally created between the inner casing and the outer casing. The air gap in this case generally extends in the axial direction only along a subsection adjacent to the inner casing and the outer casing. This air gap forms a cavity which is accessible from the volume enclosed in the outer casing, i.e. the exhaust gas flow path.

In order to coat the matrix, a coating material is for example pressed or aspirated by positive pressure or by negative pressure through the flow channels of the matrix. The surface of the flow channels is thereby coated and a catalytically active surface is therefore provided, on which the chemical reaction with the exhaust gas takes place. By introducing the coating material, the coating material may possibly also be applied to structures outside the matrix, and the coating material may in particular enter and remain in the air gap that has formed. On the one hand, this significantly increases the amount of coating material that remains in the device, and furthermore the coating material may become loosened from the air gap during operation, with the result that it is entrained in the exhaust gas flow and possibly damages components for the exhaust gas aftertreatment which lie downstream in the flow direction. In particular, so-called poisoning may occur when catalytically active material comes into contact with a different type of catalytically active material on other honeycomb bodies. A chemical reaction may then take place, which fully or at least partially destroys a downstream catalytic converter. It is therefore imperative to avoid catalytically active coating material being deposited in regions that are not intended for the coating.

In order to prevent ingress of the coating material into the air gap, the latter is filled with a filler before the introduction of the coating material. This filler may, for example, be introduced into the gap with an injection needle.

The filler material solidifies to such an extent in the air gap that it is not displaced by the introduction of the coating material and does not by itself flow out of the air gap or be aspirated therefrom.

The filler may preferably be introduced from outside the outer casing into the air gap through an opening. Alternatively, it may be introduced directly into the air gap from the open cross section of the outer casing.

It is particularly advantageous for the filler to be a gel-like organic composition. A gel-like organic composition is advantageous for ensuring that the entire air gap can be filled rapidly and easily by the filler being injected directly into the air gap. The filler preferably has material properties which allow injection into the air gap. Furthermore, the filler is provided in such a way that it achieves a sufficient strength inside the air gap, so that it cannot easily be aspirated or forced out of the air gap.

It is also advantageous for the filler to be introduced into the gaps before the device is subjected to a further heat treatment, for example drying or calcining. This is advantageous since a significant temperature elevation of the device may be reached by the drying or the calcining, and the filler preferably has a limited thermal stability so that beyond a certain thermal effect it is no longer stable, or is fully disintegrated.

One preferred exemplary embodiment is characterized in that the filler is removed from the air gap after the introduction of the catalytically active coating. This is advantageous in order to remove the filler before starting up the device. Otherwise, the filler could become loosened from the air gap during operation under the mechanical loads and the thermal interactions. And obstruct flow channels or cause damage to components in the exhaust gas system.

It can also be preferred for the filler to be removed from the air gap by a thermal process. This is advantageous since the honeycomb body, or the entire device, generally experiences a plurality of process steps in which it is exposed to highly elevated temperatures. Without providing an additional working step, it is therefore possible to ensure that the filler is heated beyond a temperature that is critical for the filler, thereby disintegrating the filler.

It is furthermore advantageous for the filling of the air gap to be carried out in such a way that the opening cross section facing toward the introduction site through which the catalytically active coating is introduced is sealed by the filler. This is particularly important in order to ensure that no coating material at all can firmly settle in the air gap. Sealing the opening cross section ensures this.

In one preferred version, the filler may be configured in such a way that it expands after introduction and possibly expels some of the introduced filler out of the air gap, in order to ensure that no coating material at all can enter the air gap.

Advantageous developments of the present invention are described in the dependent claims and in the following description of the FIGURE.

### BRIEF DESCRIPTION OF THE DRAWINGS

The invention will be explained in detail below on the basis of an exemplary embodiment with reference to the drawing. In the drawing:

The FIGURE is a sectional view through a honeycomb body received in an outer casing, the air gap formed between the inner casing of the honeycomb body and the outer casing being filled with a filler.

### DETAILED DESCRIPTION OF THE PRESENTLY PREFERRED EMBODIMENTS the

FIGURE shows a device for exhaust gas aftertreatment in a sectional view. Arranged centrally, there is a honeycomb body 1 formed from a metallic matrix. The honeycomb body 1 is received in an inner casing 2, which fixes the matrix, protects it against spreading out and uncoiling, and at the same time protects the matrix against mechanical influences. Honeycomb bodies of this design are known in a wide variety of forms in the prior art.

In the depiction of the FIGURE, the honeycomb body 1 is preceded by a heating disk 3, which is connected to the honeycomb body 1 by supporting pins 4. The heating disk 3 is connected to a voltage source via the electrical bushing 5 shown and can therefore be energized, so that heating is achieved.

The honeycomb body 1 with its inner casing 2 is inserted into an outer casing 6 and is durably connected thereto, for example by soldering. An air gap 7 is formed between the outer casing 6 and the inner casing 2. This air gap may be created deliberately as a result of the constituent part geometry, or else may be formed as a result of tolerances between the constituent parts. Air gaps are in principle also conceivable between all components of the device.

In the FIGURE, the air gap 7 is filled by a filler 8 so that nothing can enter the air gap 7, particularly from the side facing toward the heating disk 3.

The washcoat with which the matrix of the honeycomb body 1 is coated is for example pressed with positive pressure into the honeycomb body and/or drawn through the latter with negative pressure. The honeycomb body 1 may also be flushed with the washcoat. In all these methods, it is highly likely that the washcoat would penetrate into the air gap 7 if the latter is not sealed.

The filler may, for example, be introduced deliberately into the air gap 7 by an injection needle in order to fill it, and in particular to fill the open cross section.

The FIGURE is in particular not of a limiting nature, and serves to illustrate the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A method for producing a device for aftertreatment of exhaust gases and for coating a honeycomb body, provided in the device, with a catalytically active surface coating, comprising:
forming the honeycomb body from a multiplicity of metallic, at least partially structured foils which are stacked one on another and wound so that the honeycomb body forms a multiplicity of flow channels through which fluid can flow along a main flow direction;
receiving the honeycomb body in an inner casing;
durably connecting the honeycomb body to the inner casing;
arranging and durably connecting the inner casing in an outer casing;
introducing the catalytically active surface coating into the multiplicity of flow channels formed by the honeycomb body; and
filling an air gap or air gaps formed between the outer casing and at least the inner casing with a filler before the introducing the catalytically active surface coating into the multiplicity of flow channels.

8. The method as claimed in claim 7, wherein the filler is a gel-like organic composition.

9. The method as claimed in claim 7, wherein the filler is introduced into the air gap or air gaps before the device is subjected to a heat treatment, for example drying or calcining.

10. The method as claimed in claim 7, wherein the filler is removed from the air gap or air gaps after the introducing the catalytically active surface coating.

11. The method as claimed in claim 10, wherein the filler is removed from the air gap or air gaps by a thermal process.

12. The method as claimed in claim 7, wherein the filling of the air gap or air gaps is carried out such that an opening cross section facing toward an introduction site through which the catalytically active surface coating is introduced is sealed by the filler.

13. The method as claimed in claim 9, wherein the heat treatment is at least one of drying or calcining.

14. The method as claimed in claim 7, wherein the outer casing is configured as a housing.
